(19) United States
(12) Patent Application Publication
(10) Pub. No.: US 2006/0147717 A1
(43) Pub. Date: Jul. 6, 2006

(54) Image erasing method, apparatus therefor and recycling method for recording medium

(75) Inventors: Waka Hasegawa, Tokyo (JP); Yuichi Hashimoto, Tokyo (JP); Shinichiro Nishida, Tokyo (JP); Naotoshi Miyamachi, Tokyo (JP); Takayuki Sumida, Tokyo (JP); Tadashi Asano, Tokyo (JP); Masafumi Abe, Tokyo (JP); Naoko Tsuyoshi, Tokyo (JP); Ryosuke Fudou, Tokyo (JP)

Correspondence Address: FITZPATRICK CELLA HARPER & SCINTO, 30 ROCKEFELLER PLAZA, NEW YORK, NY, 10112, US

(73) Assignees: CANON KABUSHIKI KAISHA, Tokyo (JP); AJINOMOTO CO., INC., Tokyo (JP); SPACE ENVIRONMENTAL TECHNOLOGY CO., LTD., Tokyo (JP)

(21) Appl. No.: 10/545,784

(22) PCT Filed: Mar. 12, 2004
(86) PCT No.: PCT/JP04/03379

§ 371 Date: Aug. 16, 2005

(30) Foreign Application Priority Data
Mar. 13, 2003 (JP) 2003-068212

(51) Int. Cl. B32B 27/36

(52) U.S. Cl. 428/412

(57) ABSTRACT

The invention provides a method for easily and promptly erasing an image (including a character) formed on a printed article, and an apparatus employing such method. A printed article bearing an image formed on a surface including an inorganic pigment is exposed to a reactive gas, generated by creeping discharge or corona discharge induced by a voltage application between a pair of opposed electrodes, whereby the image is erased.

### TECHNICAL FIELD

The present invention relates to an image erasing method, an apparatus therefor and a recycling method for a recording medium.

### BACKGROUND ART

Along with the spreading of computers, printers, copying machines, facsimiles etc., requirement for output on paper is more and more increasing. No other media have ever become comparable to paper in visibility and portability, and realizing “electronic information society” or “paperless society” has not shown a progress as expected.

For this reason, technical development for recycling and reuse of paper is becoming increasingly important. In a prior paper recycling method, a recovered paper is repulped with water, then subjected to floating removal of an ink portion by a deinking process, further bleached and used as “recycled paper”. However such method has drawbacks that the paper strength is lowered and that a process cost is higher in comparison with a case of new papermaking. Consequently there is desired a method capable of reusing or recycling paper without a deinking process.

Based on such background, investigations are being made for a method of printing paper with an image forming material including an erasable dye composition capable of changing a color-forming compound in a colored state to an erased state. As such image forming material, Japanese Patent Application Laid-open No. S63-393177 proposes a method of utilizing a reversible change in transparency of a recording layer under a control of applied thermal energy. Also Japanese Patent Applications Laid-open Nos. S61-237684, H05-124360 and 2001-105741 propose a method of utilizing an intermolecular interaction between a color-forming agent having an electron donating property and a color developing agent having an electron accepting property. Also Japanese Patent Application Laid-open No. H11-116864 proposes an ink including a dye of which color is erasable by an electron beam irradiation, and Japanese Patent Application Laid-open No. 2001-49157 proposes an ink containing an additive having a function of erasing the color of a coloring agent by a light irradiation. WO 02/088265 proposes an ink jet ink and a recording method utilizing a monascus dye to be erasable by light irradiation.

On the other hand, Japanese Patent Application Laid-open No. H07-253736 proposes a method of decomposing and erasing an image on an ordinary paper with an activated gas.

### DISCLOSURE OF THE INVENTION

However the methods described in Japanese Patent Applications Laid-open Nos. S63-39377, S61-237684, H05-124360 and 2001-105741 are impractical since the recording medium, writing-erasing apparatus etc. are expensive in the initial cost and in the running cost. Also the method described in Japanese Patent Application Laid-open No. H11-116864, employing an electron beam irradiation, may cause a deterioration of a base material or generation of a secondary X-ray, even though slightly. Also in the method described in Japanese Patent Application Laid-open No. 2001-49157, the additive to be employed is more specifically a dye-based sensitizer and is employed in a large amount of 1/10 to 10/10 with respect to the coloring agent, thus resulting a high cost of the ink. Also investigations are being made for methods capable of erasing an image easier and faster than the methods described in WO 02/088265 and Japanese Patent Application Laid-open No. H07-253736.

Therefore, an object of the present invention is to provide a method capable of erasing an image (including a character) on a printed article easily, promptly and with a low cost, and an apparatus utilizing such method. Another object of the present invention is to provide a method of recycling a recorded recording medium as a blank recording medium with a low cost.

As a result of intensive investigations based on the aforementioned objectives, the present inventors have found that, for a printed article bearing an image with an ink jet ink on a recording medium having an inorganic pigment-based coating layer on a base material, such image can be erased easily, promptly and with a cost by exposure to an oxidizing gas, and have thus made the present invention. In the present invention, an “erasure of image” means not only a case where the image recorded on the recording medium becomes visually not at all recognizable (hereinafter called “color erasing”) but also a case where an initial image is thinned to a predetermined optical density (for example the optical density of the image being decreased to 80% of that of an original image) (hereinafter called “color density decreasing”).

In an aspect, the present invention provides a method for erasing an image of a printed article, said image being formed on a surface, containing an inorganic pigment, of a recording medium, characterized by including:

(i) a step of applying a voltage between a first electrode and a second electrode separated by a dielectric member having a surface for creeping discharge in a gaseous atmosphere of a gas capable of generating an oxidizing gas by discharge, thereby generating creeping discharge from the surface for creeping discharge to generate an oxidizing gas from the aforementioned gas; and

(ii) a step of exposing the image of the printed article to the oxidizing gas.

In another aspect, the present invention provides a method erasing an image of a printed article, said image being formed on a surface, containing an inorganic pigment, of a recording medium, characterized by including:

(a) a step of applying a negative voltage, with respect to a grounded first electrode, to a second electrode in a gaseous atmosphere of a gas capable of generating an oxidizing gas by discharge, thereby generating corona discharge between the electrodes to generate an oxidizing gas; and

(b) a step of exposing the printed article to the oxidizing gas.

In another aspect, the present invention provides an apparatus for erasing an image of a printed article, said image being formed on a surface, containing an inorganic pigment, of a recording medium, characterized by including:

(A) oxidizing gas generating means containing a first electrode, a second electrode, and a dielectric member separating such electrodes and having a surface for generating creeping discharge by a voltage application between the electrodes, wherein the surface for generating creeping discharge can be positioned in a gaseous atmosphere of a gas capable of generating an oxidizing gas by discharge; and

(B) a supporting portion for the printed article;
wherein (A) and (B) mentioned above are mutually so positioned that the printed article can be exposed to the oxidizing gas.

In another aspect, the present invention provides an apparatus for erasing, on a recording medium having a surface including an inorganic pigment, an image of a printed article having such image on such surface, characterized by including:

(1) oxidizing gas generating means including a first electrode and a second electrode, wherein the electrodes are so positioned that applying a negative voltage, with respect to the grounded first electrode, to the second electrode generates corona discharge in a gaseous atmosphere of a gas capable of generating an oxidizing gas by discharge to generate an oxidizing gas from the gas; and

(2) a supporting portion for the printed article;
wherein (1) and (2) mentioned above are mutually so positioned that the printed article can be exposed to the oxidizing gas.

In still another aspect, the present invention provides a recycling method for a recording medium characterized by including a step of erasing, on a recording medium having a surface including an inorganic pigment, an image of a printed article having such image on such surface, by the aforementioned image erasing method.

According to the present invention, since a printed article, bearing an image on a recording medium having a surface including an inorganic pigment, is exposed to an oxidizing gas generated by creeping discharge or corona discharge, a deinking step can be dispensed with and an apparatus can be made compact. It is therefore possible to achieve a color erasing or a color density decreasing easily and promptly, with a low cost. In addition, in case ionization potentials of a dye employed in an ink and of the image formed on the recording medium satisfy a specified condition, the color erasing or color density decreasing can be achieved more easily and more promptly, and there can also be obtained a surface state of the recording medium preferred in order that the image formed on the recording medium has an ionization potential that satisfies the aforementioned condition.

### BRIEF DESCRIPTION OF THE DRAWINGS

FIG. 1 is a schematic lateral view showing an example of an erasing apparatus of the present invention.

FIG. 2 is a schematic lateral view showing another example of an erasing apparatus of the present invention.

FIG. 3 is a schematic lateral view showing still another example of an erasing apparatus of the present invention.

FIG. 4 is a schematic lateral view showing still another example of an erasing apparatus of the present invention.

FIG. 5 is a schematic lateral view showing still another example of an erasing apparatus of the present invention.

FIG. 6 is a schematic lateral view showing still another example of an erasing apparatus of the present invention.

FIG. 7 is a schematic lateral view showing still another example of an erasing apparatus of the present invention.

FIG. 8 is a schematic lateral view showing still another example of an erasing apparatus of the present invention.

FIG. 9 is a schematic lateral view showing still another example of an erasing apparatus of the present invention.

### BEST MODE FOR CARRYING OUT THE INVENTION

In the following, the present invention will be clarified in more details by examples thereof.

[1] Image Erasing Method and Apparatus

The image erasing method of the present invention includes a step of exposing, to an oxidizing gas, a printed article having an image on a surface, containing an inorganic pigment, of a recording medium.

Such gas is preferably an ionized/dissociated gas or a secondary product thereof. Such secondary product is preferably at least one selected from a group of ozone, hydroxy radical, carbonate ion and a nitrogen oxide.

Such oxidizing gas is generated by creeping discharge or corona discharge.

In the following, each oxidizing gas generating means will be explained in detail, with reference to accompanying drawings. A gas capable of generating an oxidizing gas can be, for example, air, oxygen, nitrogen, carbon dioxide or water vapor. In the following there will be explained a case of employing air as an example.

(1) Creeping Discharge

In case of creeping discharge, discharge is generated along a dielectric member by applying an AC voltage between a pair of electrode separated by the dielectric member, thereby generating an oxidizing gas. A color-erasing/color-density-decreasing method in such case is preferably executed by placing a printed article or causing the printed article to run in or in the vicinity of a discharge area of the creeping discharge. Also for causing the printed article to run, it is preferable to employ at least a conveying means selected from a group of an endless belt conveying, a roll conveying and a drum conveying.

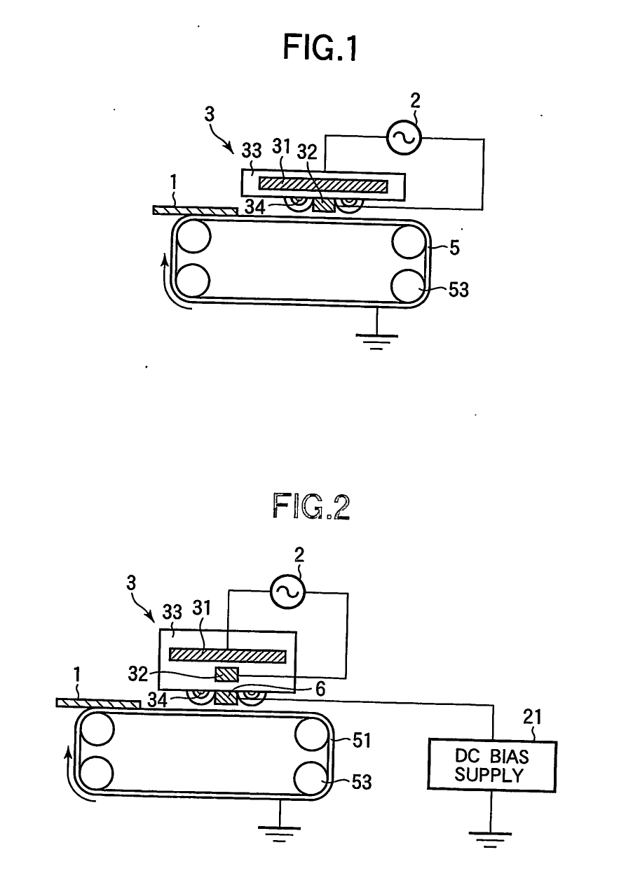

FIG. 1 is a schematic lateral view showing an example of an apparatus of the present invention for erasing an image of a printed article, for example obtained by forming an image (including a character) on a recording medium by an ink jet recording (such being hereinafter called a “printed article” unless specified otherwise). FIG. 1 shows an example of generating an oxidizing gas by applying an AC voltage to creeping discharge electrodes.

The oxidizing gas generated by creeping discharge in the air is an ionized/dissociated gas and a secondary product thereof, for example ozone, a carbonate ion, a nitrogen oxide etc. A similar oxidizing gas is generated also with corona discharge to be explained later, but the creeping discharge improves an efficiency of generation of the oxidizing gas.

Referring to FIG. 1, an electrode 3 for the creeping discharge includes a pair of electrodes 31, 32 mutually opposed and separated by a dielectric member 33. As shown in FIG. 1, an electrode 31 is embedded in the dielectric member 33, and the other electrode 32 is provided at a bottom face of the dielectric member 33. The oxidizing gas is generated in a discharge area 34, present in a vicinity of the electrode 32 provided at the bottom face of the dielectric member 33. In FIG. 1, there is also shown an AC power supply 2.

The electrodes 31, 32 are not particularly restricted in shapes thereof, and it is possible, for example, to form an electrode 31 embedded in the dielectric member 33 in a plate shape and to form the electrode 32 under the bottom face of the dielectric member 33 in a wire shape. Each of the electrodes 31, 32 may be constituted of a metal such as Al, Cr, Au, Ni, Ti, W, Te, Mo, Fe, Co or Pt, or an alloy or an oxide thereof. The electrodes 31 and 32 preferably have a mutual distance of 1 μm or larger, more preferably 3 to 200 μm. An AC voltage (Vpp) applied to the creeping discharge electrode 3 is preferably within a range of 1 to 20 kV, and preferably has a frequency of 100 Hz to 5 MHz, and it is particularly preferable to employ a voltage Vpp of 1 to 10 kV with a frequency of 1 kHz to 2 MHz, since the image erasure can be executed more efficiently. In such case, it is preferred to select a distance between the electrode 32 and the printed article to be 100 mm or less (including a distance of 0 mm corresponding to a case where the printed article and the electrode are in a mutual contact).

The dielectric member 33 is formed by a material that can form a surface capable of generating creeping discharge. Examples of such material include ceramics and glass. Specific example of the ceramics and the glass constituting the dielectric member 33 include a metal oxide such as silica, magnesia or alumina, and a nitride such as silicon nitride or aluminum nitride.

In exposing a printed article 1 to the oxidizing gas, the printed article 1 may be maintained stationary or moved relative to the discharge area 34 according to the purpose. FIG. 1 shows an example in which the printed article 1 is conveyed by a conductive endless belt 5 rotated by a roll 53 in the vicinity of creeping discharge area 34. The conductive endless belt 5 is so positioned as to pass a vicinity or an interior of the discharge area 34, whereby the discharge area 34 spreads in a space between the conductive endless belt 5 and the electrode 3 to improve a contact efficiency between the printed article 1 and the oxidizing gas. For this purpose it is preferable to ground the conductive endless belt 5 as shown in FIG. 1 or to apply a positive or negative voltage thereto. A conveying speed depends on Vₚₚ, a frequency and a distance between the electrode 32 and the printed article 1, but is preferably 2000 cm/min or less for the aforementioned ranges of the Vₚₚ, frequency and distance, and particularly preferably 500 cm/min or less, so that the image erasure can be executed more efficiently.

Conveying means for conveying the printed article 1 is not particularly limited and can be constituted by known means. In addition to the conveying by an endless belt, there can also be employed, for example, a roll conveying or a drum conveying. The conveying means is preferably constituted of a conductive material, but this is not restrictive and it may also be constituted of a non-conductive material. A conductive material constituting the conveying means can be the same as those described for the electrodes 31, 32.

The exposure of the printed article 1 to the oxidizing gas may be executed in a closed system or an open system, according to the purpose. However, it is executed preferably in a closed system in order that the oxidizing gas does not leak out from the color-density-decreasing/color-erasing apparatus. The color-density-decreasing/color-erasing apparatus is preferably provided with an adsorption filter for preventing leakage of the oxidizing gas.

FIG. 2 is a schematic lateral view showing another embodiment of the apparatus for erasing an image by creeping discharge. A component or a part equivalent to that in FIG. 1 is represented by the same reference number. An electrode 3 for creeping discharge shown in FIG. 2 is an application of a configuration of a charging/charge-eliminating apparatus described in Japanese Patent Application Laid-open No. H62-177882 to the apparatus of the present invention, and is an example in which a pair of mutually opposed electrodes 31, 32 are embedded in a dielectric member 33. In this case, the oxidizing gas is generated in a portion corresponding to an end portion of an electrode 32 at a bottom face of the dielectric member 33 (a portion indicated as a discharge area 34 shown in FIG. 2).

In the example shown in FIG. 2, as described in Japanese Patent Application Laid-open No. S62-177882, a first bias electrode 6 and a power supply 21 for supplying the first bias electrode 6 with a DC bias voltage are provided on the bottom face of the dielectric member 33. An application of the bias voltage between the first bias electrode 6 and a conductive endless belt 51 serving also as a second bias electrode causes the oxidizing gas to move from a generating position toward the printed article 1, thereby improving the contact efficiency between the printed article 1 and the oxidizing gas. The bias voltage is generally selected as 0.2 to 4.0 kV. The first bias electrode 6 can be constituted of a material the same as that for the electrodes 31, 32.

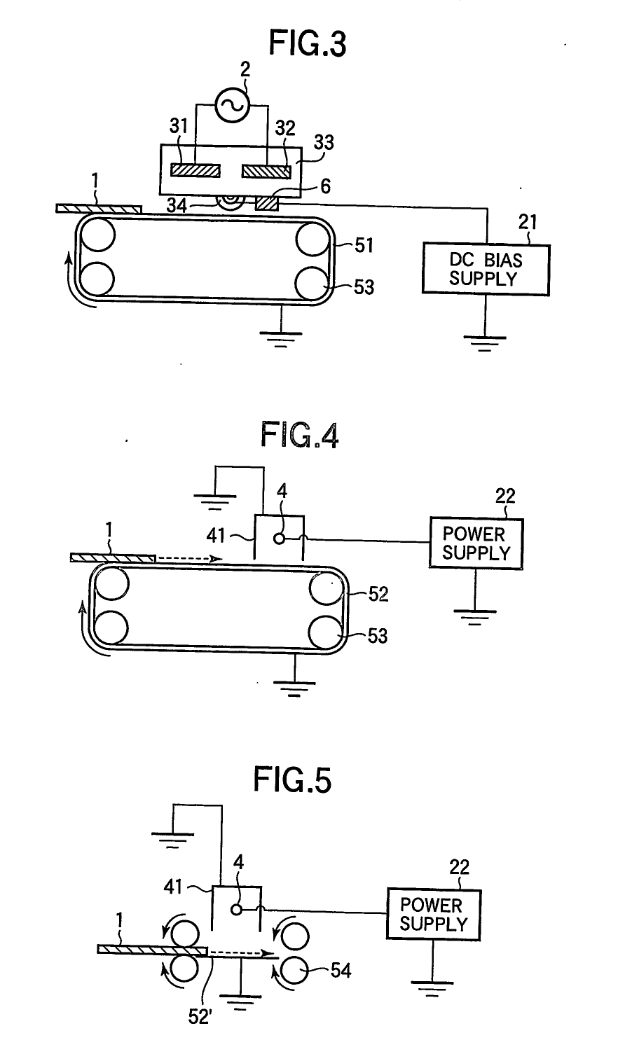

FIG. 3 is a schematic lateral view showing another embodiment of the apparatus for erasing an image by creeping discharge. A component or a part equivalent to that in FIG. 2 is represented by the same reference number. Creeping discharge electrode shown in FIG. 3 is also an application of the configuration of the charging/charge-eliminating apparatus described in Japanese Patent Application Laid-open No. S62-177882 to the color-density-decreasing/color-erasing apparatus of the present invention, and is an example in which a pair of electrodes 31, 32 are embedded so as to be arranged in parallel in a plane parallel to a bottom face of a dielectric member 33. In this case, the oxidizing gas is generated principally in the vicinity (a portion indicated as a discharge area 34 shown in FIG. 3) between electrodes 31, 32 on the bottom face of the electric member. If necessary, there may also be adopted a configuration, in which, as described in Japanese Patent Application Laid-open No. 62-177882, three electrodes are arranged on a plane parallel to the bottom face of the dielectric member 33 (not shown).

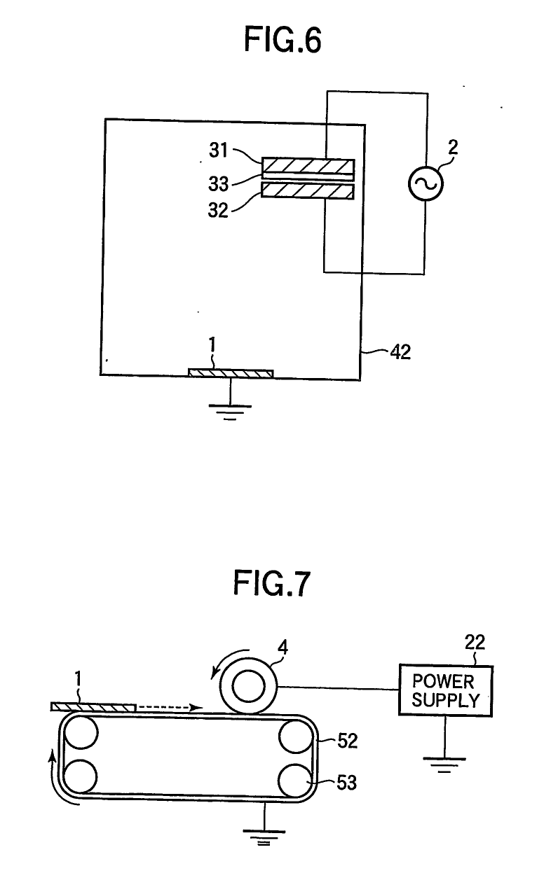

FIG. 6 is a schematic lateral view showing another embodiment of the apparatus for erasing an image by creeping discharge. A component or a part equivalent to that in FIG. 1 is represented by the same reference number. A dielectric layer 33 is provided on the electrodes 31 and/or 32. In the example shown in FIG. 6, both electrodes 31, 32 are formed in a plate shape, and the dielectric member 33 is formed on the electrode 31. A printed article 1 is not positioned between the electrode 31 and the opposed electrode 32, but is placed stationary in a closed container 42 covering the electrode 31, the dielectric member 33 and the plate-shaped counter electrode 32. The dielectric member 33 can be constituted of a material described for the case shown in FIG. 1 for utilizing the creeping discharge.

(2) Corona Discharge

In case of corona discharge, a voltage is applied between a discharge electrode and a counter electrode opposed to the discharge electrode to generate a discharge, thereby generating an oxidizing gas. The voltage applied to the discharge electrode can be an AC voltage or a DC voltage. In case of applying a DC voltage, a negative polarity is preferable. It is also possible to superpose an AC voltage with a DC voltage. The discharge is preferably generated in a state where the counter electrode is grounded. The discharge electrode can have a wire shape, a roll shape, a blade shape, a plate shape, a brush shape or a needle or bar shape. Also it is preferable to contact the counter electrode and the printed article in at least a part thereof. In the color-density-decreasing/color-erasing method in such case, it is preferable to cause the printed article to remain stationary or to run in a discharge space between the discharge electrode and the counter electrode. Also in order to cause the printed article to run, there is preferably employed at least a conveying means selected from a group of endless belt conveying, roll conveying and drum conveying. It is further preferable that the conveying means has conductivity thereby serving also as the counter electrode.

FIG. 4 is a schematic lateral view showing an example of an apparatus of the present invention for erasing, by corona discharge, an image of a printed article in which an image (including a character) is formed on a recording medium for example by an ink jet recording. A component or a part equivalent to that in FIG. 1 is represented by the same reference number. In general, corona discharge is generated by providing a discharge electrode and a counter electrode in a position opposed thereto and applying a voltage to the discharge electrode. In the apparatus shown in FIG. 4, the discharge electrode 4 is formed in a wire shape, and a conductive endless belt 52 functions as a counter electrode. In order to efficiently generate an ionized/dissociated gas and a secondary product thereof by corona discharge, it is preferable, as shown in FIG. 4, to ground the conductive endless belt 52. In FIG. 4, there are also shown a DC voltage applying means 22 and a cover 41 covering the discharge electrode 4.

The applied voltage can be a DC voltage or a DC voltage superposed with an AC voltage. A particular satisfactory image erasure can be achieved in case of applying a DC voltage of a negative polarity to the discharge electrode 4. It is considered that the application of a DC voltage of a negative polarity to the discharge electrode 4 causes an efficient generation of an ionized/dissociated gas and a secondary product thereof, principally composed of an oxidizing gas, and that such gas composition is effective for reducing the color forming property of a dye contained for example an ink jet ink.

A material constituting the discharge electrode 4 and the counter electrode 52 can be selected from those described for the creeping discharge electrodes 31, 32 in the foregoing (1) so as to match a shape or a structure of such electrodes. Electrodes shown in configurations shown in FIGS. 5 to 9 are also similarly constructed.

The corona discharge is initiated by an application of a voltage equal to or higher than a predetermined threshold voltage (discharge starting voltage). In the present invention, a DC voltage applied to the discharge electrode is preferably selected from −0.1 to −20.0 kV, particularly from −0.5 to −20.0 kV, and further preferably from −0.5 to −10.0 kV, and a distance between the discharge electrode and the printed article is preferably selected as 30 mm or less (including 0 mm in case these are in mutual contact). In this manner it is possible to further efficiently erase the image of the printed article.

The shape of the discharge electrode 4 is not particularly restricted, and can have a known shape such as, in addition to a wire shape, a roll shape, a blade shape, a plate shape, a brush shape, a needle shape or bar shape. Particularly in case of the corona discharge, a corona charger employing a wire shaped conductive material as the discharge electrode allows to obtain a uniform color-density-decreasing/color-erasing property to a dye over a wide area.

A printed article 1 is preferably in contact with the counter electrode 52, but need not necessarily be in contact. In case the printed article 1 is made present in a discharge area (area principally between the discharge electrode 4 and the counter electrode 52), the printed article 1 can be made stationary or made to run with respect to the discharge area according to the purpose. In case of an exposure to the oxidizing gas under a movement of the printed article, a moving speed of the printed article depends on a concentration of the oxidizing gas and a distance between the discharge electrode and the printed article, but is preferably 2000 cm/min or less for the aforementioned voltage and distance, and particularly preferably 500 cm/min or less, since the image erasure can be executed more efficiently.

As already explained on the creeping discharge in the foregoing (1), an exposure of the printed article 1 to the oxidizing gas may be executed in a closed system or an open system, according to the purpose, but it is executed preferably in a closed system. In case of a closed system, the printed article 1 may be placed stationary outside the discharge area (area principally between the discharge electrode 4 and the counter electrode 52).

FIG. 5 is a schematic lateral view showing another example of the apparatus for erasing, by corona discharge, an image on a recording medium. A component or a part equivalent to that in FIG. 4 is represented by the same reference number. In the example shown in FIG. 5, the printed article 1 is conveyed on a conductive plate 52′ by rolls 54, 54.

FIG. 7 is a schematic lateral view showing another example of the apparatus for erasing, by corona discharge, an image on a recording medium. A component or a part equivalent to that in FIG. 4 is represented by the same reference number. FIG. 7 shows an example provided with a roll-shaped discharge electrode 4. The roll-shaped discharge electrode 4 is in contact with a conductive endless belt 52 and is given a voltage while being rotated by the rotation of the conductive endless belt 52. The printed article 1 passes the discharge area in contact with both the roll-shaped discharge electrode 4 and the conductive endless belt 52, thus improving the contact efficiency with the oxidizing gas.

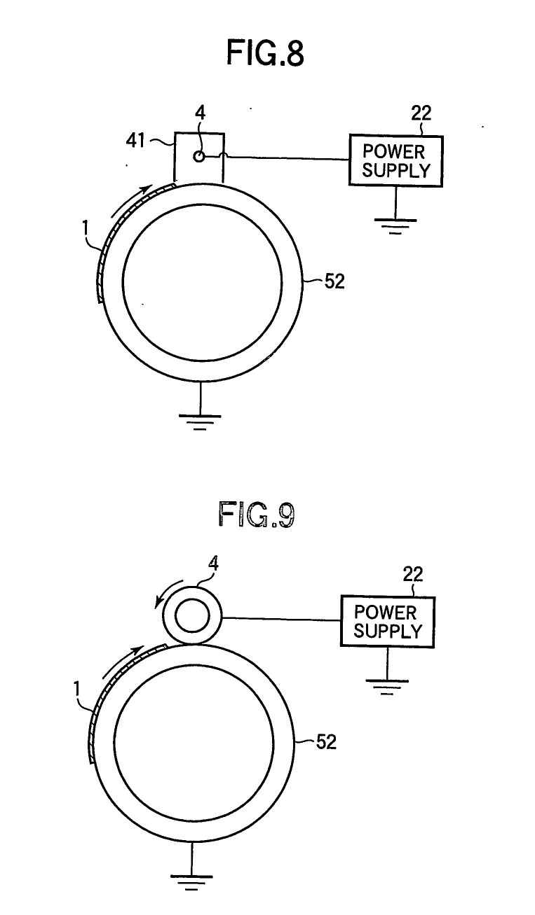

FIG. 8 is a schematic lateral view showing another example of the apparatus for erasing, by corona discharge, an image on a recording medium. A component or a part equivalent to that in FIG. 4 is represented by the same reference number. FIG. 7 shows an example of employing a conductive drum 52 as conveying means.

FIG. 9 is a schematic lateral view showing another example of the apparatus for erasing, by corona discharge, an image on a recording medium. A component or a part equivalent to that in FIG. 4 is represented by the same reference number. FIG. 7 shows an example of employing a roll-shaped discharge electrode 4 and a conductive drum 52.

The printed article of which image is erased by an action of a reactive gas generated by creeping discharge or corona discharge as in the apparatus shown in FIGS. 1 to 9 can be reused as a recording medium.

[2] Recording Medium Having an Inorganic Pigment on the Surface

In the image erasure of the present invention, an image is formed on a surface of a recording medium, having a surface including an inorganic pigment. In the present invention, therefore, there is advantageously employed a recording medium having a surface including an inorganic pigment, preferably a recording medium provided with a layer containing an inorganic pigment on a base material.

In the present invention, as will be explained later, in order to erase an image on a recording medium more easily and more promptly, it is preferable to maintain an ionization potential of an image, formed on the recording medium with an ink prepared with a dye, lower than an ionization potential of a dye powder by 0.1 [eV] or more, particularly preferably by 0.15 [eV] or more. For this purpose it is preferred that an inorganic pigment has a pore volume of 0.2 [cc/g] or higher, or a dispersion particle size of 0.5 [μm] or less.

The pore volume and the dispersion particle size of the pigment in the present invention can be determined as will be explained in the following.

In the present invention, a pore volume of the inorganic pigment can be measured with a mercury porosimeter utilizing a mercury press-in method. Since the base material and the inorganic pigment generally have different pore diameters, it is possible to calculate the pore volume of the inorganic pigment only by investigating a distribution of the pore volume as a function of a pore diameter by the mercury porosimeter.

Also the dispersion particle size can be measured with a scanning electron microscope.

The inorganic pigment to be employed in the present invention is preferably a porous material, and can be at least one selected from a group of alumina, silica, silica-alumina, colloidal silica, zeolite, clay, caolin, talc, calcium carbonate, barium sulfate, aluminum hydroxide, titanium dioxide, zinc oxide, satin white, diatomaceous clay and acidic white clay. Among these, it is preferable to use alumina or silica, more preferable alumina.

The inorganic pigment is not particularly restricted in a particle shape, which can be suitably selected such as a spherical shape or a crushed shape, but, as explained in the foregoing, there is preferably employed an inorganic pigment having a pore volume of 0.2 [cc/g] or higher, or a dispersion particle size of 0.5 [μm] or less. More preferably the pore volume is 2.0 [cc/g] or less, and the dispersion particle size is 0.01 [μm] or higher. An image printed on a recording medium having a surface including such inorganic pigment shows a much superior color erasing property in comparison with a recording medium having a surface including other inorganic pigments.

The base material employed in the present invention is not particularly restricted but can be any material such as a paper, a film, a seal, a label, a compact disk, a metal, a glass, various plastic products, a form for a delivery service, and can also be a composite material thereof. In case it is paper, there can be employed any recyclable paper, and an acidic paper, a neutral paper or an alkaline paper may be employed. A base paper is principally constituted of a chemical pulp represented by LBKP or NBKP, and a filler, and papermaking is executed by an ordinary method utilizing an internal sizing agent, a papermaking additive etc. if necessary. A mechanical pulp or a recycled pulp may be used in combination as the pulp material to be used or may be used principally. A filler can be, for example, calcium carbonate, caolin, talc, titanium dioxide etc. The base paper may further contain or applied with a hydrophilic binder, a matting agent, a hardening agent, a surfactant, a polymer latex, a polymer mordanting agent etc. The base paper preferably has a basis weight of 40 to 700 g/m².

A coat of the inorganic pigment can be applied on the base paper by preparing an aqueous coating liquid by the addition of an aqueous binder. It is confirmed that the use, as the aqueous binder, of at least either one of a water-soluble polymer including at least one of monomer units represented by the following formulas (I) and (II), and a water-soluble polymer including at least a monomer unit represented by the following formula (III) significantly improves the color-erasing/color-density-decreasing of the image, in comparison with a case of employing an ordinary water-soluble polymer: 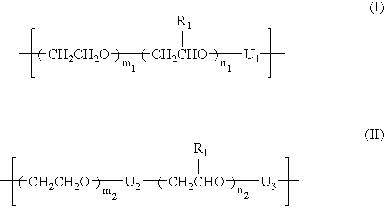
(in the formulas (I) and (II), m₁ and m₂ each independently represents an integer from 4 to 460; n₁ and n₂ each independently represents an integer from 3 to 80; R₁— and R₂— each independently represents H—, CH₃— or C₂H₅—; —U₁— to —U₃— each independently represents —OCNHR′—NHCOO—; and —R′— represents —(CH₂)₆— or a group represented by the following formula (IV) or (V): 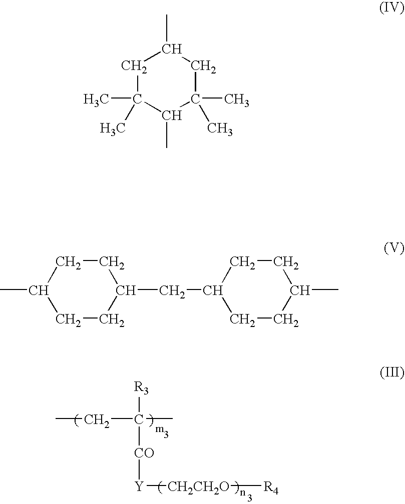
(in the formula (III), R₃— represents H— or CH₃—; —Y— represents —O— or —NH—; R₄— represents —H or a hydrocarbon group with 1 to 4 carbon atoms; and n₃ represents an integer of 1 to 25.)

The water-soluble polymer including at least one monomer unit selected from those represented by the formulas (I) and (II) preferably has a number-averaged molecular weight within a range from 5,000 to 200,000. Also at least one monomer unit selected from those represented by the formulas (I) and (II) and included in the water-soluble polymer preferably has a proportion of 10 mass % or higher with respect to all the monomer units.

Also the water-soluble polymer including at least one monomer unit selected from those represented by the formula (III) preferably has a number-averaged molecular weight within a range from 5,000 to 300,000. Also at least one monomer unit selected from those represented by the formula (III) and included in the water-soluble polymer preferably has a proportion of 10 mass % or higher with respect to all the monomer units.

In addition to at least one compound selected from the monomer units represented by the foregoing formulas (I) to (III), an ordinary water-soluble polymer may be employed as an aqueous binder. Such aqueous binder can be, for example, polyvinyl alcohol, casein, styrene-butadiene rubber, starch, polyacrylamide, polyvinylpyrrolidone, polyvinyl methyl ether, polyethylene oxide etc. but these are not restrictive. Also these water-soluble polymers may be employed singly or in a combination of two or more kinds.

The mass ratio of the inorganic pigment and the aqueous binder (inorganic pigment/aqueous binder) is preferably 0.1 to 100, more preferably 1 to 20. In case the mass ratio of the inorganic pigment and the aqueous binder (inorganic pigment/aqueous binder) exceeds 100, there tends to result falling of powder materials, and in case it is less than 0.1, it is difficult to obtain an enough color-erasing/color-density-decreasing property for the image.

The aqueous coating liquid is applied on the surface of the base paper for example by a roller coating, a blade coating, an air knife coating, a gate roll coating, a bar coating, a spray coating, a gravure coating, a curtain coating or a comma coating. After the coating, drying is executed for example with a hot air drying oven or a heat drum to obtain a surface layer containing the inorganic pigment. In case of a heat drum, a dry finishing can be achieved by pressing the surface layer to a heated finishing surface. Also, the applied layer in a moist state before drying may be processed, in order to coagulate the aqueous binder, with an aqueous solution containing a nitrate salt, a sulfate salt, a formate salt or an acetate salt of zinc, calcium, barium magnesium or aluminum.

A coating amount in solid is preferably within a range of 0.1 to 50 g/m². In a coating amount less than 0.1 g/m², it is difficult to obtain a sufficient color-erasing/color-density-decreasing effect for an ink jet print/image. On the other hand, a coating amount exceeding 50 g/m² scarcely provides an improvement in the print quality or in the color-erasing/color-density-decreasing effect for the image. In the aqueous coating liquid, there may be suitably blended, if necessary, a pigment dispersant, a moisture retaining agent, a viscosifier, a defoaming agent, a releasing agent, a colorant, a water resistant agent, a moisturizing agent, a fluorescent dye, an ultraviolet absorber etc.

[3] Coloring Agent

(1) Dye

A mechanism of erasure of an image on a recording medium by exposure to an oxidizing gas is considered as a cleaving reaction of a chemical bond in a dye molecule by oxidation. As a result of intensive investigation of the present inventors, it is found preferable, in order to achieve an efficient erasure of the dye, that the dye has an ionization potential equal to or less than 6.0 [eV]. More preferably it is equal to or higher than 4.2 [eV].

In addition, according to the investigation of the present inventors, it is clarified that the image on the recording medium can be erased more easily and more promptly by a situation where the image formed on the recording medium by an ink prepared with a dye has an ionization potential lower than an ionization potential of the dye powder by 0.1 [eV] or more, preferably by 0.15 [eV] or more. It is preferably 0.7 [eV] or less.

A mechanism thereof is not yet clarified in detail but is estimated as follows.

It is generally known that an ionization potential of a dye is closely related with a coagulation state of the dye (for example T. Ma, K. Inoue, H. Noma, K. Yao, E. Abe, “Ionization potential studies of organic dye adsorbed onto TiO₂ electrode”, Journal of Materials Science Letters, vol. 21, p. 1013-1014(2002)).

On the other hand, when an ink prepared with a dye is printed on a surface of a recording material including a porous inorganic pigment, the dye molecules are individually adsorbed in pores on the surface of the porous inorganic pigment and are prevented from coagulation, so that the image formed on the recording medium is considered to have an ionization potential lower than that of the dye powder. However, in case the porous inorganic pigment is insufficient in a pore volume or a dispersion particle size, it is difficult to obtain, in the image formed on the recording medium, a decrease in the ionization potential meeting the conditions of the present invention.

In the present invention, the ionization potential of the dye and the ionization potential of the image formed on the recording medium with the ink prepared with such dye can be determined from a contact point between a photon energy and a photoelectron emission current according to Fowler's law, utilizing an atmospheric photoelectron spectroscopy apparatus (AC-1, manufactured by Riken Keiki Co.).

In the image erasing method of the present invention, a coloring material for forming an image preferably includes a natural dye or a synthetic dye, and particularly preferably a natural dye. More preferably, the dye includes a polyene structure.

(a) Natural Dye

A natural dye can be a microbial dye produced by microorganisms or an extract dye extracted from an animal or a plant, but is preferably a microbial dye.

(a-1) Microbial Dye

A microbial dye produced by a microorganism culture allows easier production management in comparison with an extract dye, thus providing an advantage of enabling a stable mass production.

Examples of the microbial dye include a monascus dye, violacein, melanin, carotin, chlorophyll, phycobilin, flavin, phenazine, prodigiosin, violacein, an indigo-based dye, benzoquinone, naphthoquinone, and anthraquinone (Pigment microbiology, P. Z. Margalith, Chapman & Hall, London (1992)). Among these, an excellent color erasing property by a discharge process is exhibited by the monascus dye, violacein or indigo-based dye, particularly the monascus dye.

Microorganisms to be cultured can be of any strain capable of producing the aforementioned microbial dye, and a culture method is also not restricted but can be an already known culture method. The aforementioned microbial dye is usually extracted from a culture liquid of the microorganisms producing such dye, but the culture liquid may be concentrated without extraction or purification as long as ink properties can be retained.

In the following, there will be given a detailed explanation on a monascus dye which is particularly advantageously employed in the present invention.

The monascus dye is a dye produced by fungi of monascaceae genus, and has long been employed as a colorant for red wine or edible meat in China and Taiwan, so that its safety has been confirmed. The monascus dye is generally a composition of compounds similar in structure but different in substituents, such as monascorubrin of orange color, ankaflavin of yellow color, monascin of yellow color, monascorubramin, rubropunctatin and rubropunctamine of red color (J. Ferment. Technol., Vol. 51, p. 407(1973)). These compounds are insoluble in water, but monascorubrin or rubropunctatin is known to react with a water-soluble amino compound in the culture liquid to form a water-soluble complex thereby providing a red water-soluble monascus dye (Journal of Industrial Microbiology, vol. 16, pp. 163-170(1996)). The water-soluble amino compound is preferably at least one selected from a group of an amino acid, a water-soluble protein, a peptide and a nucleic acid compound.

The strain producing the monascus dye can be fungi of monascaceae genus, such as Monascus purpureus (National Institute of Technology and Evaluation, Biological Resource Center (NBRC), Catalog Number NBRC 4478), Monascus pilosus (Catalog Number NBRC 4480), Monascus ruber (Catalog Number NBRC 9203), or a variation or a mutation thereof.

A culture method for the monascus strain is not particularly restricted, and can be a solid culture method utilizing a solid culture medium or a liquid culture method utilizing a liquid culture medium. For example, a powder monascus dye can be obtained from the solid culture method, and a liquid monascus dye or an organic solvent extract thereof can be obtained from the liquid culture method. There can be employed a known culture medium containing a carbon source, a nitrogen source, inorganic salts and trace nutrition elements, and it is possible to utilize for example a culture medium containing a sugar such as glucose or sucrose, or a hydrolysis product of acetic acid or starch as the carbon source, peptone: yeast extract or malt extract as the nitrogen source; and the trace nutrition elements and a sulfate salt, a phosphate salt etc. suitably as inorganic salts.

The monascus fungi are inoculated in such culture medium and aerobically cultured for 2 to 14 days at a temperature of 20 to 40° C. In an aerated culture under agitation, the pH value need not be controlled in particular. However, in a culture under an acidic condition, the aforementioned reaction of monascorubrin or rubropunctatin with the water-soluble amino compound is hindered to provide a dye rich in monascorubrin or rubropunctatin (Journal of Industrial Microbiology, vol. 16, pp. 163-170(1996)).

The monascus dye may be extracted with an organic solvent from the culture liquid or from a bacteria fraction, or may be obtained by drying a supernatant fraction of the culture liquid. An extracting solvent can be, for example, n-propyl alcohol, methanol, ethanol, butanol, acetone, ethyl acetate, dioxane or chloroform. The extract can be purified by an ordinary isolating method such as silica gel chromatography or inverse high-speed liquid chromatography to isolate a monascus dye of a desired purity. The monascus dye thus obtained is a mixture of water-insoluble components such as monascorubrin, rubropunctatin, ankaflavin, monascin, monascorubramin and rubropunctamine, and water-soluble components formed by a combination of monascorubrin or rubropunctatin with a water-soluble amino compound in the course of the culture.

The monascus dye shows an improvement in the color-erasing/color-density-decreasing property by containing a water-soluble component. It is therefore preferable, to the monascus dye obtained by the culture, to a water-soluble amino compound further thereby increasing a proportion of the complex of monascorubrin or rubropunctatin with the water-soluble amino compound. The water-soluble amino compound to be added is preferably at least one selected from a group of an amino acid, a water-soluble protein, a peptide and a nucleic acid compound. A complex with such specified water-soluble amino compound is superior in the color-erasing/color-density-decreasing property.

For example, in a culture under an acidic condition, the reaction of monascorubrin or rubropunctatin with the water-soluble amino compound is suppressed whereby a water-insoluble dye is principally formed. A feeding culture utilizing acetic acid as a pH regulating agent provides monascorubrin and rubropunctatin in a particularly large amount. A water-soluble dye can be obtained by adding a water-soluble amino compound in an excess amount to the culture liquid, then adjusting the pH value to neutral and eliminating the bacteria by centrifuging or filtration. Also by executing a culture under an acidic condition, then extracting a dye including monascorubrin and rubropunctatin from the culture liquid with an organic solvent and executing a reaction with a water-soluble amino compound, it is possible to reduce impurities other than the dye and to obtain a dye constituted of a mixture of limited dye components thereby further improving the color erasing property. An extracting solvent to be employed in such case can be, for example, ethyl acetate, acetone, butanol, ethanol or methanol. It is more effective to rinse the extract with water after extraction with ethyl acetate. For the reaction of the extracted dye and the water-soluble amino compound, there is preferably employed a 50 mass % aqueous solution of ethanol, a 50 mass % aqueous solution of methanol or a 50 mass % aqueous solution of acetonitrile, but such is not restrictive.

(a-2) Extract Dye

An extract dye can be, for example, a dye extracted from a plant such as a turmeric dye, a gardenia dye, carotin, a sufflower dye, an annatto dye, a cayenne dye, a perilla dye, a grape juice dye, a beet dye, a red cabbage dye, a purple sweet potato dye, a chlorophyll dye, a cacao dye, or an indigo dye, or an animal dye such as lac dye, a cochineal dye or a sepia dye. However, these examples are not restrictive. Also, among the aforementioned extract dyes, a gardenia dye or a cayenne dye is particularly preferable.

(b) Synthetic Dye

A synthetic dye can be, for example, that of anthraquinone type, triphenylmethane type, phthalocyanine type, polyene type or indigo type. However, these examples are not restrictive.

[4] Ink for Ink Jet

An image in the present invention is formed on the aforementioned recording medium for example by an ink jet recording method utilizing an ink jet ink containing the aforementioned various coloring agents. Such ink jet ink can be prepared by dissolving and/or dispersing the aforementioned various coloring agents in water or an organic solvent.

(1) Solvent

An organic solvent can be known one ordinarily employed in an ink jet ink. Specific examples thereof include an alcohol, a glycol, a glycol ether, a fatty acid ester, a ketone, an ether, a hydrocarbon solvent and a polar solvent. Water may be added in case the organic solvent is water-soluble. A water content in such case is preferably within a range of 30 to 95 mass % with respect to the total mass of the ink.

As the organic solvent, an alcohol or a glycol is preferable. Examples of alcohol include methanol, ethanol, 1-propanol, 2-propanol, 1-butanol, 2-butanol, isobutyl alcohol and t-butyl alcohol.

Examples of glycol include ethylene glycol, diethylene glycol, triethylene glycol, polyethylene glycol, propylene glycol, dipropylene glycol, polypropylene glycol, butylenes glycol, hexanediol, pentanediol, glycerin, hexanetriol and thiodiglycol.

These organic solvent may be employed singly or in a suitable combination of two or more kinds. For example, there can be employed a combination of an alcohol and/or a glycol and a polar solvent. Examples of the polar solvent include 2-pyrrolidone, formamide, N,N-dimethylformamide, N,N-dimethylacetamide, dimethyl sulfoxide, sulforan, N-methyl-2-pyrrolidone, N-vinyl-2-pyrrolidone, 2-oxazolidone, 1,3-dimethyl-2-imidazolidinone, acetonitrile and acetone.

The aforementioned dye may be dissolved in water or in an organic solvent, or may be pulverized with various dispersing equipment (such as a ball mill, a sand mill, an attriter, a roll mill, an agitator mill, a Henshell mixer, a colloid mill, an ultrasonic homogenizer, a pearl mill, a jet mill or an ong mill) according to the necessity and dispersed with a suitable dispersant (surfactant). The surfactant can be cationic, anionic, amphoteric or nonionic.

The ink jet ink may further contain, if necessary, a binder, a pH regulating agent, a viscosity regulating agent, a penetrating agent, a surface tension regulating agent, an antioxidant, an antiseptic, an antimold agent etc.

The content of the aforementioned dye is preferably 0.01 to 90 mass % with respect to the entire mass of the color erasable ink (composition), more preferably 0.5 to 15 mass %. In this manner there can be obtained a satisfactory printing property.

Also a print on the recording medium with the aforementioned ink can be made by an ink jet printing method or by a method utilizing a writing utensil of a pen shape or the like.

[5] Time Necessary for Color Erasure

An image constituted of the aforementioned various coloring agents can fade (color density decrease) by an exposure to an oxidizing gas, and can be finally erased to a visually unrecognizable level. Stated differently, by an exposure of a printed article to the oxidizing gas, the image becomes paler and eventually not observable. The image erasure is significantly influenced by a discharge voltage, but a time necessary for the color erasure is variable depending on a contact efficiency with the oxidizing gas, a composition of the oxidizing gas, a dye type, a dye concentration, a dye composition, a printing material etc. A color erasing time can be regulated by suitably selecting these conditions.

Also, the image erasing method of the present invention is applicable not only in a case of erasing an image of a printed article thereby reusing it as a recording medium, but also in case of utilizing a printed article, after the image erasure, as a raw material for producing a recycled paper.

### EXAMPLES

In the following, the present invention will be clarified in further details by examples, but the present invention is not limited to such examples.

(Recording Medium Preparation Example 1)

Fine alumina powder (trade name: CATALOID AP-3, manufactured by Shokubai Kasei Kogyo Co.) and polyvinyl alcohol (trade name: SMR-10HH, manufactured by Shinetsu Chemical Co.) were mixed in a mass ratio of 90/10, and mixed with water under agitation so as to obtain a solid content of 20 mass %. The mixture was applied on a PET film so as to obtain a mass of 30 g/m² after drying, and was dried for 10 minutes at 110° C. to obtain a recording medium 1.

(Recording Medium Preparation Example 2)

In a 2-liter flask equipped with an agitator, 800 g of polyethylene glycol (average molecular weight 2000), 65 g of hexamethylene siisocyanate, 2 g of dibutyl tin laurate and 900 g of ethylene glycol dimethyl ether were charged, uniformly mixed by agitation for 30 minutes at the room temperature, then heated for 2 hours at 80° C. under agitation and cooled to obtain a highly viscous transparent liquid (binder A). The obtained liquid showed a viscosity of 30,000 mPas at 25° C., and the polymer contained in ethylene glycol dimethyl ether solvent had a number-average molecular weight of 85,000. Then a recording medium 2 was obtained in the same manner as the recording medium 1 except that polyvinyl alcohol was replaced by the binder A obtained in the aforementioned process.

(Recording Medium Preparation Example 3)

In a 2-liter flask equipped with an agitator, 300 g of hydroxyethyl methacrylate, 350 g of water, 350 g of methanol and 1.5 g of azobisisobutyronitrile were charged, and agitated for 60 minutes at the room temperature. Then nitrogen gas was blown in to sufficiently replace the interior of the flask, the temperature was gradually raised under gradual nitrogen gas passing to 65° C. Then the mixture was polymerized for 3 hours in this state, and was cooled to obtain a highly viscous transparent liquid (binder B). The obtained liquid showed a viscosity of 1,800 mPa·s at 25° C., and the polymer contained in water/methanol mixed solvent had a number-average molecular weight of 150,000. Then a recording medium 3 was obtained in the same manner as the recording medium 1 except that polyvinyl alcohol was replaced by the binder B obtained in the aforementioned process.

(Recording Medium Preparation Example 4)

Colloidal silica (trade name: SNOWTEX C, manufactured by Nissan Chemical Co.) and polyvinyl alcohol (trade name: SMR-10HH, manufactured by Shinetsu Chemical Co.) were mixed in a mass ratio of 90/10, and mixed with water under agitation so as to obtain a solid content of 20 mass %. The mixture was applied on a PET film so as to obtain a mass of 30 g/m² after drying, and was dried for 10 minutes at 110° C. to obtain a recording medium 4.

(Ink preparation examples 1 to 5)

Components shown in the following Table 1 were mixed, dissolved under sufficient agitation, and pressure filtered with a Fluoropore filter (trade name, manufactured by Sumitomo Denko Co.) of a pore size of 0.45 μm to obtain inks 1 to 5. Tetrasodium copper phthalocyanine tetrasulfonate was manufactured by Kishida Kagaku Co. A gardenia dye, a cayenne dye and a chlorophyll were manufactured by Kiriya Kagaku Co. Also indigo carmine was manufactured by Nakarai Tesk Co.

TABLE 1

| | ink 1 | ink 2 | ink 3 | ink 4 | ink 5 |
|---|---|---|---|---|---|
| tetrasodium copper | 2.5 | | | | |
| phthalocyanine | | | | | |
| tetrasulfonate | | | | | |
| gardenia yellow dye | | 2.5 | | | |
| cayenne dye | | | 2.5 | | |
| chlorophyll | | | | 2.5 | |
| indigo carmine | | | | | 2.5 |
| glycerin | 7.5 | 7.5 | 7.5 | 7.5 | 7.5 |
| diethylene glycol | 7.5 | 7.5 | 7.5 | 7.5 | 7.5 |
| acetylenol EH* | 0.1 | 0.1 | 0.1 | 0.1 | 0.1 |
| water | 82.4 | 82.4 | 82.4 | 82.4 | 82.4 |

(unit: mass %)
*Acetylenol EH (trade name, manufactured by Kawaken Fine Chemical Co.): ethylene oxide addition product of acetylene alcohol (HLB = 14-15)

(Ink Preparation Example 6)

In a 500-ml Sakaguchi flask, 100 ml of a yeast-malt (YM) culture medium (composed of 1 mass % of glucose, 0.3 mass % of yeast extract (manufactured by Difco Laboratories, Inc.), 0.3 mass % of malt extract (manufactured by Difco Laboratories, Inc.), 0.5 mass % of bactopeptone (manufactured by Difco Laboratories, Inc.), and water in the remainder) were charged, adjusted to a pH value of 6.5 and sterilized under a pressure for 20 minutes at 120° C. After cooling, Monascus purpureus (NBRC 4478) subjected to an inclined culture on a YM agar culture medium was inoculated by an amount of one platinum spatula, and subjected to a vibration culture for 2 days at 30° C. to obtain a seed bacterial liquid. 5 ml of thus obtained seed bacterial liquid were inoculated in 100 ml of a YM culture medium, sterilized as described above, and subjected to a main culture under vibration for 3 days at 30° C. After the main culture, the culture liquid was centrifuged (9000 rpm, 10 min) to separate a supernatant liquid and bacteria. The obtained supernatant liquid showed an optical absorbance of 0.2 at a wavelength of 500 nm in 1/100 dilution in distilled water. The supernatant liquid was added with ethanol of the same amount, and, after agitation, was centrifuged (9000 rpm, 10 min) to eliminate water-insoluble dyes. The obtained supernatant liquid was concentrated to dry to obtain a water-soluble red dye. The dye was mixed with a ratio of dye/ethanol=10.0/90.0 then dissolved under sufficient agitation and filtered with a Fluoropore filter (trade name, manufactured by Sumitomo Denko Co.) of a pore size of 0.45 μm to obtain an ink 6.

### Culture Examples 1 to 4

In a 5-liter Sakaguchi flask, 1 liter of a YM culture medium same as in the ink production example 6 was charged, adjusted to a pH value of 6.5 and sterilized under a pressure for 20 minutes at 120° C. After cooling, Monascus purpureus (NBRC 4478) subjected to an inclined culture on a YM agar culture medium was inoculated by an amount of one platinum spatula, and subjected to a vibration culture for 2 days at 30° C. to obtain a seed bacterial liquid.

Separately, in a 1-liter glass jar, 450 ml of a YM culture medium same as above were charged, then sterilized under a pressure for 20 minutes at 120° C., and, after cooling, the seed bacterial liquid was inoculated by 10% (v/v). An aeration agitated culture was conducted for 7 days at 30° C., maintaining the culture liquid at a pH value of 4.0 from the start of the culture, utilizing sulfuric acid in the culture example 1, phosphoric acid in the culture example 2 or acetic acid in the culture example 3, as a pH regulating agent. In the culture example 4, the pH value at the start was adjusted to 6.5, and the culture was conducted without pH adjustment thereafter. The production amount of monascorubrin in the culture liquid obtained in the culture examples 1 to 4 was measured by HPLC. Conditions of HPLC analysis were taken from a method described in WO02/088265. Obtained results are shown in Table 2.

TABLE 2

| | | | monascorubrin |
|---|---|---|---|
| | pH regulating | controlled | production |
| | agent | pH | amount (mg/L) |
| Culture example 1 | sulfuric acid | 4.0 | 220.5 |
| Culture example 2 | phosphoric acid | 4.0 | 259.6 |
| Culture example 3 | acetic acid | 4.0 | 953.5 |
| Culture example 4 | none | none | 7.4 |

As shown in Table 2, the amount of monascorubrin was evidently increased by a culture under an acidic condition, and was further increased by employing acetic acid as the pH regulating agent, in comparison with a mineral acid such as sulfuric acid or phosphoric acid. Rubropunctatin and monascorubramin obtained by such culture method can be employed in an addition reaction with an amino compound thereby obtaining a water-soluble dye in a more efficient manner.

(Ink Preparation Example 7)

The culture liquid obtained in the culture example 3 was centrifuged (9000 rpm, 10 min) to separate a supernatant liquid and bacteria. The obtained dye-containing wet bacteria were lyophilized to determine a water content, which was 75.6 mass %.

400 g of the obtained wet bacteria were added with 10 liters of ethyl acetate, and the mixture was agitated for 1 hour and filtered with a filter paper to separated a filtrate and bacteria. The aqueous layer was removed from the filtrate to obtain an ethyl acetate layer. The obtained ethyl acetate extract was rinsed twice by adding water of the same amount. The ethyl acetate extract after rinsing was dried by concentration to obtain a red-orange colored dye containing monascorubrin and rubropunctatin.

10.8 g of the obtained red-orange dye were added with acetonitrile to obtain 2095 ml of an acetonitrile solution containing red-orange dye. An aqueous solution of monosodium glutamate (30 mg/ml) of the same amount was added thereto, and the mixture was reacted for 3 days at the room temperature under agitation, and was dried by concentration to obtain a water-soluble dye. The obtained dye was so mixed as to obtain a ratio of dye/glycerin/diethylene glycol/acetylenol/water=2.5/7.5/7.5/0.1/82.4 (mass ratio), then dissolved under sufficient agitation and was filtered with a Fluoropore filter (trade name, manufactured by Sumitomo Denko Co.) of a pore size of 0.45 μm to obtain an ink 7.

After the reaction for generating the water-soluble dye by the addition of monosodium glutamate, monascorubrin and rubropunctatin in the reaction liquid were analyzed by inverse HPLC, but monascorubrin and rubropunctatin were not detected. Also on a liquid obtained by diluting the reaction liquid to 1/100, an optical absorbance at 500 nm was measured as 68.

(Printed Article Preparation Examples 1 to 10)

The obtained inks 1 to 7 were used to conduct solid print with an on-demand type ink jet printer (trade name: Wonder BJ F-660, manufactured by Canon Corp.) utilizing a heat generating element as an ink discharging energy source on the recording media 1-4 to obtain printed articles 1-10. The contents of the printed articles are shown in Table 3.

TABLE 3

| | Recording | |
|---|---|---|
| | medium | Ink |
| Printed article 1 | 1 | 1 |
| Printed article 2 | 2 | 1 |
| Printed article 3 | 3 | 1 |
| Printed article 4 | 4 | 1 |
| Printed article 5 | 1 | 2 |
| Printed article 6 | 1 | 3 |
| Printed article 7 | 1 | 4 |
| Printed article 8 | 1 | 5 |
| Printed article 9 | 1 | 6 |
| Printed article 10 | 1 | 7 |

(Evaluation of Color-Erasing/Color-Density-Decreasing Property)

### Examples 1 to 10

In an apparatus shown in FIG. 1 and explained in the foregoing item [1] (1) (dielectric member: alumina ceramics, electrode embedded in the dielectric member: chromium, electrode provided on the bottom face of the dielectric member: chromium), under an application of an AC voltage of a frequency of 5 kHz, and an applied voltage Vₚₚ of 4.5 kV to the discharge electrode, printed articles 1-10 were conveyed with a speed of 120 mm/min. The creeping discharge electrode 3 and the endless belt 5 were so arranged that the chromium electrode on the bottom face of the dielectric member and the printed article had a distance of 1.0 mm. The printed articles employed in the examples 1 to 10 respectively correspond, in this order, to the printed articles 1 to 10.

### Example 11

In an apparatus shown in FIG. 4 and explained in the foregoing item [1] (2) [discharge electrode (wire): tungsten, counter electrode (conductive endless belt): carbon-containing polycarbonate], under an application of a DC voltage of −1.5 kV to the discharge electrode, a printed article 10 was conveyed with a speed of 10 mm/min.

### Example 12

In an apparatus shown in FIG. 5 and explained in the foregoing item [1] (2) [discharge electrode (wire): tungsten, counter electrode (conductive plate): aluminum], under an application of a DC voltage of −1.5 kV to the discharge electrode, a printed article 10 was conveyed with a speed of 10 mm/min.

### Example 13

In an apparatus shown in FIG. 6 and explained in the foregoing item [1] (2) (dielectric member: alumina ceramics, discharge electrode: aluminum, counter electrode: aluminum), an AC voltage of a frequency of 10 kHz and an applied voltage Vₚₚ of 10 kV was applied. A printed article 10 was let to stand for 2 hours in this apparatus.

### Examples 14 to 16

In an apparatus shown in FIG. 6 and explained in the foregoing item [1] (2) [discharge electrode (conductive roll): carbon-containing silicone rubber, counter electrode (conductive drum): carbon-containing silicone rubber], under an application of DC voltages shown in Table 4 to the discharge electrode, a printed article 10 was conveyed with a speed of 10 mm/min.

### Example 17

In an apparatus shown in FIG. 8 and explained in the foregoing item [1] (2) [discharge electrode (wire): tungsten, counter electrode (conductive drum): aluminum], under an application of a DC voltage of −1.5 kV to the discharge electrode, a printed article 10 was conveyed with a speed of 10 mm/min.

### Example 18

In an apparatus shown in FIG. 9 and explained in the foregoing item [1] (2) [discharge electrode (conductive roll): carbon-containing silicone rubber, counter electrode (conductive drum): carbon-containing silicone rubber], under an application of a voltage obtained by superposing an AC voltage of a frequency of 1 kHz and an applied voltage of 1.5 kV with a DC voltage of −1.5 kV to the discharge electrode, a printed article 10 was conveyed with a speed of 10 mm/min.

### Comparative Example 1

The ink 7 was solid printed with an on-demand type ink jet printer (trade name: Wonder BJ F-660, manufactured by Canon Corp.) utilizing a heat generating element as an ink discharging energy source on a Bright Recycled paper (manufactured by Fuji Xerox Co.) to obtain a printed article 12. In an apparatus shown in FIG. 1 and explained in the foregoing item [1] (1) (dielectric member: alumina ceramics, electrode embedded in the dielectric member: chromium, electrode provided on the bottom face of the dielectric member: chromium), under an application of an AC voltage of a frequency of 5 kHz, and an applied voltage Vₚₚ of 4.5 kV to the discharge electrode, the obtained printed article 12 was conveyed with a speed of 120 mm/min.

### Comparative Example 2

The printed article 10 was let to stand for 20 hours at a position (2000 lux) at a distance of 25 cm below from a daylight color fluorescent lamp.

In each printed article subjected to a discharge process in examples 1 to 18 and comparative examples 1, 2, optical densities of the print before and after the discharge process (before and after light irradiation in comparative example 2) by a color transmission/reflection densitometer (trade name: X-Rite 310TR, manufactured by X-Rite, Inc.), and the optical density after the discharge process relative to the optical density before the discharge process (optical density retention rate=optical density after discharge process/optical density before discharge process) was determined. Results are shown in Table 4 (Tables 4(1) to 4(4)).

TABLE 4

| | Example 1 | Example 2 | Example 3 | Example 4 | Example 5 |
|---|---|---|---|---|---|
| Printed article | | | | | |
| recording medium | alumina coat paper | alumina coat paper | alumina coat paper | silica coat paper | alumina coat paper |
| dye in ink | tetrasodium copper | tetrasodium copper | tetrasodium copper | monascus dye | gardenia dia |
| | phthalocyanine | phthalocyanine | phthalocyanine | | |
| | tetrasulfonate | tetrasulfonate | tetrasulfonate | | |
| Discharge process | | | | | |
| apparatus | | | | | |
| type of discharge | creeping discharge | creeping discharge | creeping discharge | creeping discharge | creeping discharge |
| material of creeping discharge | | | | | |
| electrode | | | | | |
| electrode embedded in | chromium | chromium | chromium | chromium | chromium |
| dielectric member | | | | | |
| electrode under bottom face | chromium | chromium | chromium | chromium | chromium |
| of dielectric member | | | | | |
| type of voltage | AC | AC | AC | AC | AC |
| AC frequency (kHz) | 5 | 5 | 5 | 5 | 5 |
| AC applied voltage (kV) | 4.5 | 4.5 | 4.5 | 4.5 | 4.5 |
| DC applied voltage (kV) | — | — | — | — | — |
| conveying speed (mm/min) | 120 | 120 | 120 | 120 | 120 |
| distance between electrode on | 1.0 | 1.0 | 1.0 | 1.0 | 1.0 |
| bottom face of dielectric member | | | | | |
| and printed article (mm) | | | | | |
| Optical density retention rate (%) | 81 | 61 | 62 | 50 | 52 |
| | Example 6 | Example 7 | Example 8 | Example 9 | Example 10 |
| Printed article | | | | | |
| recording medium | alumina coat paper | alumina coat paper | alumina coat paper | alumina coat paper | alumina coat paper |
| dye in ink | cayenne dye | chlorophyll | indigocarmine | monascus dye | monascus dye |
| Discharge process | | | | | |
| apparatus | | | | | |
| type of discharge | creeping discharge | creeping discharge | creeping discharge | creeping discharge | creeping discharge |
| material of creeping discharge | | | | | |
| electrode | | | | | |
| electrode embedded in | chromium | chromium | chromium | chromium | chromium |
| dielectric member | | | | | |
| electrode under bottom face | chromium | chromium | chromium | chromium | chromium |
| of dielectric member | | | | | |
| material of corona discharge | | | | | |
| electrode | | | | | |
| discharge electrode | — | — | — | — | — |
| counter electrode | — | — | — | — | — |
| type of voltage | AC | AC | AC | AC | AC |
| AC frequency (kHz) | 5 | 5 | 5 | 5 | 5 |
| AC applied voltage (kV) | 4.5 | 4.5 | 4.5 | 4.5 | 4.5 |
| DC applied voltage (kV) | — | — | — | — | — |
| conveying speed (mm/min) | 120 | 120 | 120 | 120 | 120 |
| distance between electrode on | 1.0 | 1.0 | 1.0 | 1.0 | 1.0 |
| bottom face of | | | | | |
| dielectric member and printed | | | | | |
| article (mm) | | | | | |
| Optical density retention rate (%) | 10 | 44 | 9 | 6 | 8 |
| | Example 11 | Example 12 | Example 13 | Example 14 | Example 15 |
| Printed article | | | | | |
| recording medium | alumina coat paper | alumina coat paper | alumina coat paper | alumina coat paper | alumina coat paper |
| dye in ink | monascus dye | monascus dye | monascus dye | monascus dye | monascus dye |
| Discharge process | | | | | |
| apparatus | | | | | |
| type of discharge | corona discharge | corona discharge | creeping discharge | corona discharge | corona discharge |
| material of creeping discharge | | | | | |
| electrode | | | | | |
| electrode embedded in | — | — | — | — | — |
| dielectric member | | | | | |
| electrode under bottom face | — | — | — | — | — |
| of dielectric member | | | | | |
| material of corona discharge | | | | | |
| electrode | | | | | |
| discharge electrode | tungsten wire | tungsten wire | aluminum | carbon-containing | carbon-containing |
| | | | | silicon rubber | silicon rubber |
| counter electrode | carbon-containing | aluminum | aluminum | carbon-containing | carbon-containing |
| | polycarbonate | | | silicon rubber | silicon rubber |
| type of voltage | DC | DC | AC | DC | DC/AC |
| AC frequency (kHz) | — | — | 10 | — | 1 |
| AC applied voltage (kV) | — | — | 10 | — | 1.5 |
| DC applied voltage (kV) | −1.5 | −1.5 | — | −1.5 | −0.7 |
| conveying speed (mm/min) | 10 | 10 | | 10 | 10 |
| distance between electrode on | 10 | 10 | 100 | 0 | 0 |
| bottom face of dielectric member | | | | | |
| and printed article (mm) | | | | | |
| Optical density retention rate (%) | 10 | 10 | 4 | 20 | 10 |
| | Example 16 | Example 17 | Example 18 | Comp. Example 1 | Comp. Example 2 |
| Printed article | | | | | |
| recording medium | alumina coat paper | alumina coat paper | alumina coat paper | alumina coat paper | alumina coat paper |
| dye in ink | monascus dye | monascus dye | monascus dye | monascus dye | monascus dye |
| Discharge process | | | | | |
| apparatus | | | | | — |
| type of discharge | corona discharge | corona discharge | corona discharge | creeping discharge | — |
| material of creeping discharge | | | | | |
| electrode | | | | | |
| electrode embedded in | — | — | — | chromium | — |
| dielectric member | | | | | |
| electrode under bottom face | — | — | — | chromium | — |
| of dielectric member | | | | | |
| material of corona discharge | | | | | |
| electrode | | | | | |
| discharge electrode | carbon-containing | tungsten | tungsten | — | — |
| | silicon rubber | | | | |
| counter electrode | carbon-containing | aluminum | aluminum | — | — |
| | silicon rubber | | | | |
| type of voltage | DC/AC | DC | DC/AC | AC | — |
| AC frequency (kHz) | 1 | — | 1 | 5 | — |
| AC applied voltage (kV) | 1.5 | — | 1.5 | 4.5 | — |
| DC applied voltage (kV) | −0.5 | −1.5 | −1.5 | — | — |
| conveying speed (mm/min) | 10 | 10 | 10 | 120 | — |
| distance between electrode on | 0 | 10 | 0 | 10 | |
| bottom face of dielectric member | | | | | |
| and printed article (mm) | | | | | |
| Ultraviolet irradiation process | | | | | |
| illumination intensity (1×) | — | — | — | — | 2,000 |
| irradiation time (hr) | — | — | — | — | 20 |
| Optical density retention rate (%) | 44 | 8 | 10 | 99 | 20 |

As will be apparent from Table 4, examples 1 to 18, in which printed articles formed with ink jet ink on members applied with inorganic pigments are exposed to an oxidizing gas generated by creeping discharge or corona discharge, show low optical density retention rates and excellent color-erasing/color-density-decreasing property. The color-erasing/color-density-decreasing property is excellent particularly in case of employing a natural dye as the dye, and more excellent in case of employing a monascus dye. It is also indicated that, in case of applying a DC voltage in corona discharge, the color-erasing/color-density-decreasing property can be improved by employing a negative polarity. It is also indicated that the color-erasing/color-density-decreasing property is particularly excellent in case of employing alumina as the inorganic pigment of the member applied with the inorganic pigment.

(Recording Medium Preparation Examples 5-8)

Various fine colloidal silica powders and polyvinyl alcohol (trade name: SMR-10HH, manufactured by Shinetsu Chemical Co.) were mixed in a mass ratio of 90/10, and mixed with water under agitation so as to obtain a solid content of 20 mass %. The mixture was applied on an A4-sized plain paper so as to obtain a mass of 30 g/m² after drying, and was dried for 10 minutes at 110° C. to obtain recording media 5 to 8.

The pore volume and a dispersion particle size of the obtained recording medium were measured by the aforementioned methods. Results are shown in Table 5.

TABLE 5

| | Pore volume of | |
|---|---|---|
| | silica particle | Dispersion particle size |
| | [cc/g] | of silica particle [μm] |
| Recording medium 5 | 0.2 | 0.5 |
| Recording medium 6 | 0.3 | 0.5 |
| Recording medium 7 | 0.5 | 0.2 |
| Recording medium 8 | 0.6 | 0.1 |

(Recording Medium Preparation Examples 9-13)

Various fine alumina powders and polyvinyl alcohol (trade name: SMR-10HH, manufactured by Shinetsu Chemical Co.) were mixed in a mass ratio of 90/10, and mixed with water under agitation so as to obtain a solid content of 20 mass %. The mixture was applied on an A4-sized plain paper so as to obtain a mass of 30 g/m² after drying, and was dried for 10 minutes at 110° C. to obtain recording media 9 to 13. A pore volume and a dispersion particle size of the obtained recording medium were measured by the aforementioned methods. Results are shown in Table 6.

TABLE 6

| | Pore volume of | |
|---|---|---|
| | alumina particle | Dispersion particle size |
| | [cc/g] | of alumina particle [μm] |
| Recording medium 9 | 0.2 | 0.7 |
| Recording medium 10 | 0.4 | 0.5 |
| Recording medium 11 | 0.6 | 0.15 |
| Recording medium 12 | 0.7 | 0.1 |
| Recording medium 13 | 0.9 | 0.07 |

(Ink Preparation Examples 8 to 10)

Components shown in the following Table 7 were mixed, dissolved under sufficient agitation, and pressure filtered with a Fluoropore filter (trade name, manufactured by Sumitomo Denko Co.) of a pore size of 0.45 μm to obtain inks. A gardenia dye and a cayenne dye were manufactured by Kiriya Kagaku Co. Tetrasodium copper phthalocyanine tetrasulfonate was manufactured by Kishida Kagaku Co. A pore volume and a dispersion particle size of the obtained recording medium were measured by the aforementioned methods. Results are shown in Table 7.

TABLE 7

| | Ink 8 | Ink 9 | Ink 10 |
|---|---|---|---|
| Gardenia blue dye | 2.5 | — | — |
| Cayenne dye | — | 2.5 | — |
| Tetrasodium copper | — | — | 2.5 |
| phthalocyanine tetrasulfonate | | | |
| Glycerin | 7.5 | 7.5 | 7.5 |
| Diethylene glycol | 7.5 | 7.5 | 7.5 |
| Acetylenol EH | 0.1 | 0.1 | 0.1 |
| Water | 82.4 | 82.4 | 82.4 |

(Printed Article Preparation Examples 13 to 25)

The obtained inks 8 to 10 were used to conduct solid print on the recording media 5 to 8 in the same manner as in the preparation examples 1 to 10 to obtain printed articles. The ionization potential of the dye and the ionization potential of the image formed on the recording medium with the ink prepared with such dye were measured with an atmospheric photoelectron spectroscopy apparatus (AC-1, manufactured by Riken Keiki Co.). Results are shown in Table 8.

(Printed Article Preparation Examples 26 to 36)

The obtained inks 5 and 6 were used to conduct solid print on the recording media 9 to 13 in the same manner as in the preparation examples 1 to 10 to obtain printed articles. The ionization potential of the dye and the ionization potential of the image formed on the recording medium with the ink prepared with such dye were measured with an atmospheric photoelectron spectroscopy apparatus (AC-1, manufactured by Riken Keiki Co.). Results are shown in Table 9.

(Evaluation of Color-Erasing/Color-Density-Decreasing Property)

### Examples 19 to 30

In an apparatus as in example 1, under an application of an AC voltage of a frequency of 15 kHz, and an applied voltage Vₚₚ of 8 kV to the discharge electrode, printed articles 13 to 25 were conveyed with a speed of 180 mm/min. The creeping discharge electrode 3 and the endless belt 5 were so arranged that the chromium electrode on the bottom face of the dielectric member and the printed article had a distance of 0.8 mm.

### Examples 31 to 40

In an apparatus as in example 11, under an application of a DC voltage of −7.5 kV to the discharge electrode, printed articles 26 to 36 were conveyed with a speed of 60 mm/min. The charger 41 and the endless belt 52 were so arranged that the discharge electrode (tungsten) and the printed article had a mutual distance of 1.0 mm.

In each printed article subjected to a discharge process in examples 19 to 40, optical densities of the print before and after the discharge process by a color transmission/reflection densitometer (trade name: X-Rite 310TR, manufactured by X-Rite, Inc.), and the optical density after the discharge process relative to the optical density before the discharge process (optical density retention rate) was determined. Results are shown in Tables 8 and 9.

TABLE 8

| | Recording | | Ionization potential of | Ionization potential | Optical density |
|---|---|---|---|---|---|
| | medium | Dye in ink | dye powder [eV] | of image [eV] | retention rate [%] |
| Example 19 | Recording medium 5 | gardenia blue | 5.3 | 5.2 | 25 |
| Example 20 | Recording medium 6 | gardenia blue | 5.3 | 5.15 | 22 |
| Example 21 | Recording medium 7 | gardenia blue | 5.3 | 5.09 | 19 |
| Example 22 | Recording medium 8 | gardenia blue | 5.3 | 5.02 | 17 |
| Example 23 | Recording medium 5 | cayenne | 5.95 | 5.85 | 19 |
| Example 24 | Recording medium 6 | cayenne | 5.95 | 5.77 | 18 |
| Example 25 | Recording medium 7 | cayenne | 5.95 | 5.69 | 15 |
| Example 26 | Recording medium 8 | cayenne | 5.95 | 5.63 | 13 |
| Example 27 | Recording medium 5 | tetrasodium copper | 6.05 | 6.01 | 77 |
| | | phthalocyanine tetrasulfonate | | | |
| Example 28 | Recording medium 6 | tetrasodium copper | 6.05 | 5.98 | 68 |
| | | phthalocyanine tetrasulfonate | | | |
| Example 29 | Recording medium 7 | tetrasodium copper | 6.05 | 5.95 | 61 |
| | | phthalocyanine tetrasulfonate | | | |
| Example 30 | Recording medium 8 | tetrasodium copper | 6.05 | 5.93 | 55 |
| | | phthalocyanine tetrasulfonate | | | |

TABLE 9

| | Recording | | Ionization potential of | Ionization potential | Optical density |
|---|---|---|---|---|---|
| | medium | Dye in ink | dye powder [eV] | of image [eV] | retention rate [%] |
| Example 31 | Recording medium 9 | monascus dye | 5.45 | 5.34 | 17 |
| Example 32 | Recording medium 10 | monascus dye | 5.45 | 5.3 | 14 |
| Example 33 | Recording medium 11 | monascus dye | 5.45 | 5.27 | 9 |
| Example 34 | Recording medium 12 | monascus dye | 5.45 | 5.23 | 7 |
| Example 35 | Recording medium 13 | monascus dye | 5.45 | 5.2 | 6 |
| Example 36 | Recording medium 9 | indigo carmine | 5.85 | 5.7 | 25 |
| Example 37 | Recording medium 10 | indigo carmine | 5.85 | 5.55 | 18 |
| Example 38 | Recording medium 11 | indigo carmine | 5.85 | 5.49 | 15 |
| Example 39 | Recording medium 12 | indigo carmine | 5.85 | 5.37 | 12 |
| Example 40 | Recording medium 13 | indigo carmine | 5.85 | 5.32 | 9 |

As will be apparent from FIGS. 8 and 9, an excellent color-erasing/color-density-decreasing property is obtained in a printed article in which a dye has an ionization potential equal to or less than 6.0 eV and the image formed on the recording medium with an ink prepared with such dye has an ionization potential lower than the ionization potential of the dye powder by 0.1 eV or more, particularly by 0.15 eV or more. A particularly excellent color-erasing/color-density-decreasing property is obtained in case of employing a monascus dye, a cayenne dye or an indigo carmine dye.

1. A method for erasing an image of a printed article, said image being formed on a surface, containing an inorganic pigment, of a recording medium, comprising the steps of:
(i) applying a voltage between a first electrode and a second electrode separated by a dielectric member having a surface for creeping discharge in a gaseous atmosphere of a gas capable of generating an oxidizing gas by discharge, thereby generating creeping discharge from said surface for creeping discharge to generate an oxidizing gas from said gas; and
(ii) exposing the image of said printed article to said oxidizing gas.

2. The method according to claim 1, wherein said second electrode is supported on said surface for creeping discharge, an AC voltage having a voltage (Vₚₚ) of 1 to 20 kV and a frequency of 100 Hz to 5 MHz is applied between said first electrode and said second electrode, and a distance between a surface of said printed article bearing the image and said second electrode is maintained at 0 to 100 mm.

3. The method according to claim 1 or 2, wherein the exposure of said printed article to the oxidizing gas is executed in a state where said printed article is placed at a standstill, or is moved with a speed of 2000 cm/min or less relative to said surface for creeping discharge.

4. The method for erasing, on a recording medium having a surface including an inorganic pigment, an image of a printed article bearing said image on said surface, comprising the steps of:
(a) applying a negative voltage, with respect to a grounded first electrode, to a second electrode in a gaseous atmosphere of a gas capable of generating an oxidizing gas by a discharge, thereby generating corona discharge between the electrodes to generate an oxidizing gas; and
(b) exposing said printed article to said oxidizing gas.

5. The method according to claim 4, wherein said first electrode is contacted with at least a part of said printed article.

6. The method according to claim 4 or 5, wherein the voltage applied to said second electrode is −0.5 to −20.0 kV and said printed article is exposed to said oxidizing gas at a position with a distance of 0 to 100 mm from said second electrode.

7. The method according to any one of claims 4 to 6, wherein, in said step (b), the printed article is placed at a standstill in a discharge space between the first electrode and the second electrode, or is moved with a speed of 2000 cm/min or less relative to said discharge space.

8. The method according to any one of claims 1 to 7, wherein said inorganic pigment is alumina or silica.

9. The method according to any one of claims 1 to 8, wherein said inorganic pigment has a pore volume of 0.2 [cc/g] or higher, or a dispersion particle size of 0.5 [μm] or less.

10. The method according to any one of claims 1 to 9, wherein the surface of said recording medium includes a polymer containing at least one unit selected from following formulas (I) and (II), and having a number-average molecular weight within a range of 5,000 to 200,000: 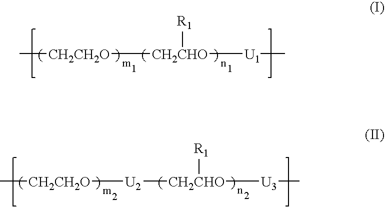
in the formulas (I) and (II), m₁ and m₂ each independently represents an integer from 4 to 460; n₁ and n₂ each independently represents an integer from 3 to 80; R₁— and R₂— each independently represents H—, CH₃— or C₂H₅—; —U₁—, —U₂— and —U₃— each independently represents —OCNHR′—NHCOO—; and —R′— represents —(CH₂)₆— or a group represented by the following formula (IV) or (V)):

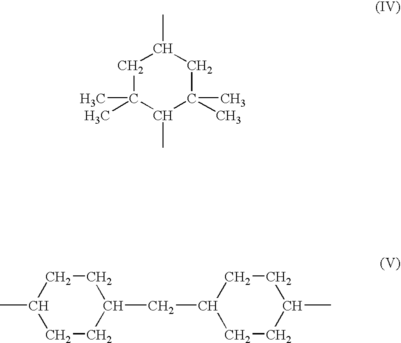

11. The method according to any one of claims 1 to 10, wherein the surface of said recording medium includes a polymer containing at least one unit represented by the following formula (III), and having an average molecular weight within a range of 5,000 to 300,000: 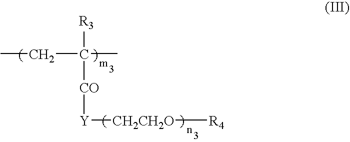
(in the formula (III), R₃— represents H— or CH₃—; —Y— represents —O— or —NH—; R₄— represents —H or a hydrocarbon group with 1 to 4 carbon atoms; and n₃ represents an integer of 1 to 25.)

12. The method according to any one of claims 1 to 11, wherein said image includes a natural dye or a synthetic dye.

13. The method according to claim 12, wherein said dye has an ionization potential of equal to or lower than 6.0 [eV], and an image formed on the recording medium by an ink prepared with said dye has an ionization potential lower than the ionization potential of said dye by 0.1 [eV] or more.

14. The method according to claim 12 or 13, wherein said dye has a polyene structure.

15. The method according to any one of claims 12 to 14, wherein said natural dye is a microbial dye produced by microorganisms, or an extract dye extracted from an animal or a plant.

16. The method according to any one of claims 12 to 15, wherein said microbial dye is a monascus dye or an indigo-based dye.

17. The method according to claim 16, wherein said monascus dye includes a water-soluble dye.

18. The method according to claim 17, wherein said water-soluble dye is a complex in which monascorubrin or rubropunctatin is bonded with a water-soluble amino compound.

19. The method according to claim 18, wherein said water-soluble amino compound is at least one selected from the group consisting of an amino acid, a water-soluble protein, a peptide and a nucleic acid compound.

20. The method according to any one of claims 17 to 19, wherein said monascus dye includes a water-soluble dye formed by reacting (a) monascorubrin and/or rubropunctatin extracted with a solvent from a culture liquid of a culture of a monascus strain, with (b) at least one water-soluble amino compound selected from the group consisting of an amino acid, a water-soluble protein, a peptide and a nucleic acid compound.

21. The method according to claim 20, wherein said monascorubrin and rubropunctatin extracted with a solvent from a culture liquid of a culture of a monascus strain are extracted from a culture liquid cultured under an acidic condition.

22. The method according to claim 21, wherein said monascorubrin and rubropunctatin extracted with a solvent from a culture liquid of a culture of a monascus strain are extracted from a culture liquid cultured under an acidic condition with feeding of acetic acid.

23. The method according to any one of claims 1 to 22, wherein said image is formed by ink jet recording.

24. An apparatus for erasing, on a recording medium having a surface including an inorganic pigment, an image of a printed article bearing said image on said surface, comprising:
(A) oxidizing gas generating means containing a first electrode, a second electrode, and a dielectric member separating said electrodes and having a surface for generating creeping discharge by a voltage application between the electrodes, wherein said surface for generating creeping discharge can be positioned in a gaseous atmosphere of a gas capable of generating an oxidizing gas by a discharge; and
(B) a supporting portion for said printed article;
wherein said (A) and (B) are mutually so positioned that said printed article can be exposed to said oxidizing gas.

25. An apparatus according to claim 24, wherein said second electrode is supported on said surface for generating creeping discharge, and said (A) and (B) are so positioned that said second electrode and said printed article are maintained at a distance of 0 to 100 mm.

26. An apparatus for erasing an image of a printed article, said image being formed on a surface, containing an inorganic pigment, of a recording medium, comprising:
(1) oxidizing gas generating means including a first electrode and a second electrode wherein the electrodes are so positioned that applying a negative voltage, with respect to said grounded first electrode, to said second electrode generates corona discharge in a gaseous atmosphere of a gas capable of generating an oxidizing gas by discharge to generate an oxidizing gas from said gas; and
(2) a supporting portion for said printed article;
wherein said (1) and (2) are mutually so positioned that said printed article can be exposed to said oxidizing gas.

27. The apparatus according to claim 26, wherein said (1) and (2) are so positioned that said second electrode and said printed article are maintained at a distance of 0 to 100 mm.

28. A recycling method for a recording medium comprising erasing an image of a printed article, said image being formed on a surface, containing an inorganic pigment, of a recording medium, by the image erasing method according to any one of claims 1 to 23.
